(19) United States
(12) Patent Application Publication
(10) Pub. No.: US 2009/0156409 A1
(43) Pub. Date: Jun. 18, 2009

(54) FAULT CURRENT LIMITER INCORPORATING A SUPERCONDUCTING ARTICLE

(75) Inventors: Drew W. Hazelton, Selkirk, NY (US); Kasegn Tekletsadik, Danvers, MA (US); Wayne A. Ordon, Schenectady, NY (US)

Correspondence Address: LARSON NEWMAN ABEL & POLANSKY, LLP, 5914 WEST COURTYARD DRIVE, SUITE 200, AUSTIN, TX, 78730, US

(73) Assignee: SUPERPOWER, INC., Schenectady, NY (US)

(21) Appl. No.: 11/958,260

(22) Filed: Dec. 17, 2007

(51) Int. Cl. H01B 12/00

(52) U.S. Cl. 505/230; 428/332

(57) ABSTRACT

A fault current limiter (FCL) article is disclosed including a superconducting tape segment that includes a substrate, a buffer layer overlying the substrate, and a high temperature superconducting (HTS) layer overlying the buffer layer, wherein the superconducting tape segment forms a meandering path that is continuous having a plurality of windings. The article also includes a shunting circuit electrically connected to the superconducting tape segment.

### CROSS-REFERENCE TO RELATED APPLICATION(S)

### BACKGROUND

1. Field of the Disclosure

The present disclosure is directed to fault current limiters, and is particularly directed to fault current limiters utilizing superconducting articles.

2. Description of the Related Art

Current limiting devices are critical in electric power transmission and distribution systems. For various reasons, such as lightning strikes, grounded wires or animal interference, short circuit conditions can develop in various sections of a power grid causing a sharp surge in current. If this surge of current, which is often referred to as fault current, exceeds the protective capabilities of the switchgear equipment deployed throughout the grid system, it could cause catastrophic damage to the grid equipment and customer loads that are connected to the system.

Superconductors, especially high-temperature superconducting (HTS) materials, are well suited for use in a current limiting device because the effect of a “variable impedance” under certain operating conditions. Superconductor materials have long been known and understood by the technical community. Low-temperature superconductors (low-T_{c} or LTS) exhibiting superconducting properties at temperatures requiring use of liquid helium (4.2 K), have been known since 1911. However, it was not until somewhat recently that oxide-based high-temperature (high-T_{c}) superconductors have been discovered. Around 1986, a first high-temperature superconductor (HTS), having superconducting properties at a temperature above that of liquid nitrogen (77 K) was discovered, namely YBa₂Cu₃O₇₋ₓ (YBCO), followed by development of additional materials over the past 15 years including Bi₂Sr₂Ca₂Cu₃O_{10+y} (BSCCO), and others. The development of high-T_{c} superconductors has created the potential of economically feasible development of superconductor components and other devices incorporating such materials, due partly to the cost of operating such superconductors with liquid nitrogen rather than the comparatively more expensive cryogenic infrastructure based on liquid helium.

Of the myriad of potential applications, the industry has sought to develop use of such materials in the power industry, including applications for power generation, transmission, distribution, and storage. In this regard, it is estimated that the inherent resistance of copper-based commercial power components is responsible for billions of dollars per year in losses of electricity, and accordingly, the power industry stands to gain based upon utilization of high-temperature superconductors in power components such as transmission and distribution power cables, generators, transformers, and fault current interrupters/limiters. In addition, other benefits of high-temperature superconductors in the power industry include a factor of 3-10 increase of power-handling capacity, significant reduction in the size (i.e., footprint) and weight of electric power equipment, reduced environmental impact, greater safety, and increased capacity over conventional technology. While such potential benefits of high-temperature superconductors remain quite compelling, numerous technical challenges continue to exist in the production and commercialization of high-temperature superconductors on a large scale.

Among the challenges associated with the commercialization of high-temperature superconductors, many exist around the fabrication of a superconducting tape segment that can be utilized for formation of various power components. A first generation of superconducting tape segment includes use of the above-mentioned BSCCO high-temperature superconductor. This material is generally provided in the form of discrete filaments, which are embedded in a matrix of noble metal, typically silver. Although such conductors may be made in extended lengths needed for implementation into the power industry (such as on the order of a kilometer), due to materials and manufacturing costs, such tapes do not represent a widespread commercially feasible product.

Accordingly, a great deal of interest has been generated in the so-called second-generation HTS tapes that have superior commercial viability. These tapes typically rely on a layered structure, generally including a flexible substrate that provides mechanical support, at least one buffer layer overlying the substrate, the buffer layer optionally containing multiple films, an HTS layer overlying the buffer film, and an optional capping layer overlying the superconductor layer, and/or an optional electrical stabilizer layer overlying the capping layer or around the entire structure. However, to date, numerous engineering and manufacturing challenges remain prior to full commercialization of such second generation-tapes and devices incorporating such tapes.

In addition to the obstacles posed by the formation of multilayered superconducting articles, utilization of such superconducting articles in certain applications can pose unique obstacles. Particularly, in light of the ever increasing power consumption, utilization of superconducting articles in components such as fault current limiters (FCL) is desirable. However, unlike the use of superconducting articles in long-length conductors, utilization of multilayered superconducting articles in fault current limiter (FCL) devices have unique requirements. Such articles should have the capacity to handle the increasing power demands, and also be capable of handling severe changes in the system, with enhanced response time, performance and durability.

### SUMMARY

According to a first aspect a fault current limiter (FCL) article is provided that includes a superconducting tape segment. The superconducting tape segment includes a substrate, a buffer layer overlying the substrate, and a high temperature superconducting (HTS) layer overlying the buffer layer, and may also include a capping layer overlying the superconductor layer and/or an optional electrical stabilizer layer overlying the capping layer or around the entire structure, such that the superconducting tape segment forms a meandering path that is continuous and includes a plurality of windings. The fault current limiter article also includes a shunting circuit electrically connected to the superconducting tape segment.

According to another aspect a fault current limiter (FCL) article is provided that includes a housing, bushings extending from the housing, and a matrix assembly within the housing electrically coupled to the bushings, the matrix assembly comprising at least one superconducting fault current limiter assembly. The superconducting tape segment includes a substrate tape, a buffer layer overlying the substrate, and a high temperature superconducting (HTS) layer overlying the buffer layer, and may also include a capping layer overlying the superconductor layer and/or an optional electrical stabilizer layer overlying the capping layer or around the entire structure, wherein the superconducting tape segment forms a meandering path that is continuous and has a plurality of windings. The article also includes a shunting circuit electrically connected to the superconducting tape segment.

According to another aspect a fault current limiter (FCL) article is provided that includes a base having a major surface defining a major plane, and a superconducting tape segment suspended over the base on its side, such that planes tangential to one of the opposite major surfaces of the superconducting tape segment are substantially perpendicular to the major plane of the base. The superconducting tape segment includes a substrate, a buffer layer overlying the substrate, and a high temperature superconducting (HTS) layer overlying the buffer layer, and may also include a capping layer overlying the superconductor layer and/or an optional electrical stabilizer layer overlying the capping layer or around the entire structure, wherein the superconducting tape segment forms a meandering path that is continuous, and has a plurality of windings. The article also includes a shunting circuit that includes a plurality of electrical contacts connected to the superconducting tape segment, wherein the shunting circuit and the superconducting tape segment have an impedance ratio in the non-superconducting state of not less than about 5:1 between the impedance of the superconducting tape segment and the impedance of the shunting circuit.

### BRIEF DESCRIPTION OF THE DRAWINGS

The present disclosure may be better understood, and its numerous features and advantages made apparent to those skilled in the art by referencing the accompanying drawings.

FIG. 1 illustrates a perspective view showing the generalized structure of a superconducting article according to an embodiment.

FIG. 2 illustrates a diagram of a superconducting tape segment having a meandering path design and parallel connected shunt coil(s) according to one embodiment.

FIG. 3 illustrates a diagram of a superconducting tape segment having a meandering path design and parallel connected shunt coil(s) according to one embodiment.

FIG. 4 illustrates a diagram of a superconducting tape segment having a meandering path design with local tape rotation near a contact point and parallel shunting circuit according to one embodiment.

FIG. 5 illustrates a side view of a superconducting tape segment having a meandering path design and a parallel shunting circuit according to one embodiment.

FIG. 6 illustrates a perspective view of multiple superconducting tape segments configured in a meandering path design according to one embodiment.

FIG. 7 illustrates a FCL article according to one embodiment.

FIG. 8 illustrates placement of a FCL article in a power grid according to one embodiment.

FIG. 9 illustrates placement of a FCL article in a power grid according to one embodiment.

FIG. 10 illustrates placement of a FCL article in a power grid according to one embodiment.

FIG. 11 illustrates a plot of current versus time for four FCL test samples.

FIG. 12 illustrates a plot of energy versus time for four FCL test samples.

The use of the same reference symbols in different drawings indicates similar or identical items.

### DESCRIPTION OF THE PREFERRED EMBODIMENT(S)

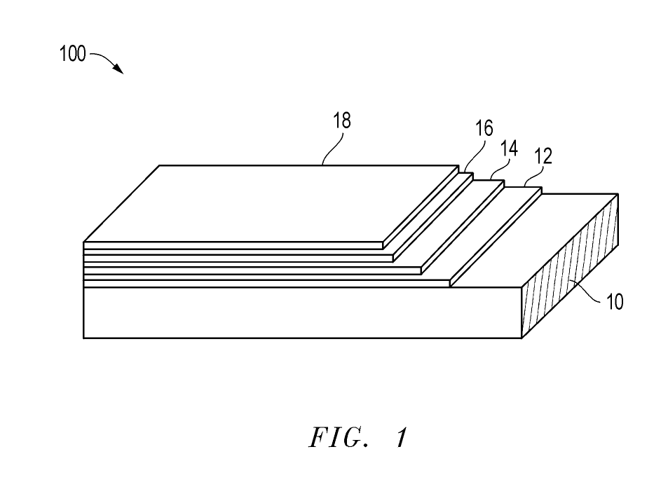

Turning to FIG. 1, the generalized layered structure of a superconducting article 100 according to an embodiment of the present invention is depicted. The superconducting article includes a substrate 10, a buffer layer 12 overlying the substrate 10, a superconducting layer 14, followed by a capping layer 16, typically a noble metal, and a stabilizer layer 18, typically a non-noble metal such as copper. The buffer layer 12 may consist of several distinct films. The stabilizer layer 18 may extend around the periphery of the superconducting article 100, thereby encasing it.

The substrate 10 is generally metal-based, and typically, an alloy of at least two metallic elements. Particularly suitable substrate materials include nickel-based metal alloys such as the known Hastelloy® or Inconel® group of alloys. These alloys tend to have desirable creep, chemical and mechanical properties, including coefficient of expansion, tensile strength, yield strength, and elongation. These metals are generally commercially available in the form of spooled tapes, particularly suitable for superconducting tape fabrication, which typically will utilize reel-to-reel tape handling.

The substrate 10 is typically in a tape-like configuration, having a high dimension ratio. As used herein, the term ‘dimension ratio’ is used to denote the ratio of the length of the substrate or tape to the next longest dimension, the width of the substrate or tape. For example, the width of the tape is generally on the order of about 0.1 to about 10.0 cm, and the length of the tape is typically at least about 0.1 m, most typically greater than about 5.0 m. Indeed, superconducting tapes that include substrate 10 may have a length on the order of 100 m or above. Accordingly, the substrate may have a dimension ratio which is fairly high, on the order of not less than 10, not less than about 10², or even not less than about 10³. Certain embodiments are longer, having a dimension ratio of 10⁴ and higher.

In one embodiment, the substrate is treated so as to have desirable surface properties for subsequent deposition of the constituent layers of the superconducting tape. For example, the surface may be polished to a desired flatness and surface roughness. Additionally, the substrate may be treated to be biaxially textured as is understood in the art, such as by the known RABiTS (roll assisted biaxially textured substrate) technique, although embodiments herein typically utilize a non-textured, polycrystalline substrate, such as commercially available nickel-based tapes noted above.

Turning to the buffer layer 12, the buffer layer may be a single layer, or more commonly, be made up of several films. Most typically, the buffer layer includes a biaxially textured film, having a crystalline texture that is generally aligned along crystal axes both in-plane and out-of-plane of the film. Such biaxial texturing may be accomplished by IBAD. As is understood in the art, IBAD is acronym that stands for ion beam assisted deposition, a technique that may be advantageously utilized to form a suitably textured buffer layer for subsequent formation of a superconducting layer having desirable crystallographic orientation for superior superconducting properties. Magnesium oxide is a typical material of choice for the IBAD film, and may be on the order of about 1 to about 500 nanometers, such as about 5 to about 50 nanometers. Generally, the IBAD film has a rock-salt like crystal structure, as defined and described in U.S. Pat. No. 6,190,752, incorporated herein by reference.

The buffer layer may include additional films, such as a barrier film provided to directly contact and be placed in between an IBAD film and the substrate. In this regard, the barrier film may advantageously be formed of an oxide, such as yttria, and functions to isolate the substrate from the IBAD film. A barrier film may also be formed of non-oxides such as silicon nitride. Suitable techniques for deposition of a barrier film include chemical vapor deposition and physical vapor deposition including sputtering. Typical thicknesses of the barrier film may be within a range of about 1 to about 200 nanometers. Still further, the buffer layer may also include an epitaxially grown film(s), formed over the IBAD film. In this context, the epitaxially grown film is effective to increase the thickness of the IBAD film, and may desirably be made principally of the same material utilized for the IBAD layer such as MgO or other compatible materials.

In embodiments utilizing an MgO-based IBAD film and/or epitaxial film, a lattice mismatch between the MgO material and the material of the superconducting layer exists. Accordingly, the buffer layer may further include another buffer film, this one in particular implemented to reduce a mismatch in lattice constants between the superconducting layer and the underlying IBAD film and/or epitaxial film. This buffer film may be formed of materials such as YSZ (yttria-stabilized zirconia) strontium ruthenate, lanthanum manganate, and generally, perovskite-structured ceramic materials. The buffer film may be deposited by various physical vapor deposition techniques.

While the foregoing has principally focused on implementation of a biaxially textured film in the buffer stack (layer) by a texturing process such as IBAD, alternatively, the substrate surface itself may be biaxially textured. In this case, the buffer layer is generally epitaxially grown on the textured substrate so as to preserve biaxial texturing in the buffer layer. One process for forming a biaxially textured substrate is the process known in the art as RABiTS (roll assisted biaxially textured substrates), generally understood in the art.

The superconducting layer 14 is generally in the form of a high-temperature superconductor (HTS) layer. HTS materials are typically chosen from any of the high-temperature superconducting materials that exhibit superconducting properties above the temperature of liquid nitrogen, 77K. Such materials may include, for example, YBa₂Cu₃O₇₋ₓ, Bi₂Sr₂CaCu₂O_{z}, Bi₂Sr₂Ca₂Cu₃O_{10+y}, Tl₂Ba₂Ca₂Cu₃O_{10+y}, and HgBa₂ Ca₂CU₃ O_{8+y}. One class of materials includes REBa₂Cu₃O₇₋ₓ, wherein RE is a rare earth or combination of rare earth elements. Of the foregoing, YBa₂Cu₃O₇₋ₓ, also generally referred to as YBCO, may be advantageously utilized. YBCO may be used with or without the addition of dopants, such as rare earth materials, for example samarium. The superconducting layer 14 may be formed by any one of various techniques, including thick and thin film forming techniques. Preferably, a thin film physical vapor deposition technique such as pulsed laser deposition (PLD) can be used for a high deposition rates, or a chemical vapor deposition technique can be used for lower cost and larger surface area treatment. Typically, the superconducting layer has a thickness on the order of about 0.1 to about 30 microns, most typically about 0.5 to about 20 microns, such as about 1 to about 5 microns, in order to get desirable amperage ratings associated with the superconducting layer 14.

The superconducting article may also include a capping layer 16 and a stabilizer layer 18, which are generally implemented to provide a low resistance interface and for electrical stabilization to aid in prevention of superconductor burnout in practical use. More particularly, layers 16 and 18 aid in continued flow of electrical charges along the superconductor in cases where cooling fails or the critical current density is exceeded, and the superconducting layer moves from the superconducting state and becomes resistive. Typically, a noble metal is utilized for capping layer 16 to prevent unwanted interaction between the stabilizer layer(s) and the superconducting layer 14. Typical noble metals include gold, silver, platinum, and palladium. Silver is typically used due to its cost and general accessibility. The capping layer 16 is typically made to be thick enough to prevent unwanted diffusion of the components from the stabilizer layer 18 into the superconducting layer 14, but is made to be generally thin for cost reasons (raw material and processing costs). Various techniques may be used for deposition of the capping layer 16, including physical vapor deposition, such as DC magnetron sputtering.

The stabilizer layer 18 is generally incorporated to overlie the superconducting layer 14, and in particular, overlie and directly contact the capping layer 16 in the particular embodiment shown in FIG. 1. The stabilizer layer 18 functions as a protection/shunt layer to enhance stability against harsh environmental conditions and superconductivity quench. The layer is generally dense and thermally and electrically conductive, and functions to bypass electrical current in case of failure of the superconducting layer or if the critical current of the superconducting layer is exceeded. It may be formed by any one of various thick and thin film forming techniques, such as by laminating a pre-formed copper strip onto the superconducting tape, by using an intermediary bonding material such as a solder. Other techniques have focused on physical vapor deposition, typically evaporation or sputtering, as well as wet chemical processing such as electro-less plating, and electroplating. In this regard, the capping layer 16 may function as a seed layer for deposition of copper thereon. Notably, the capping layer 16 and the stabilizer layer 18 may be altered or not used, as described below in accordance with various embodiments.

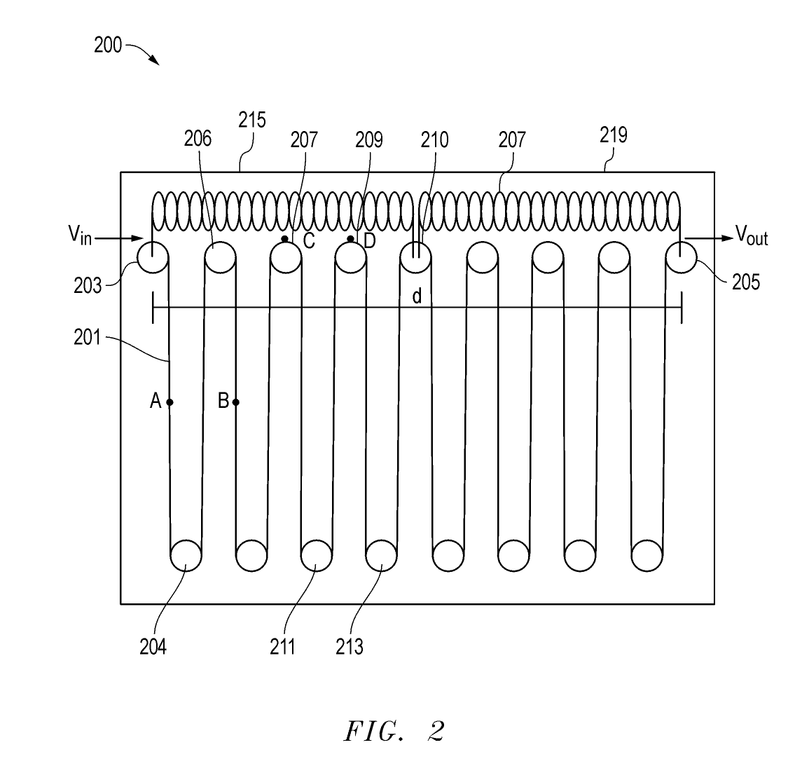

Referring to FIG. 2, a diagram of a FCL article 200 including a continuous superconducting tape segment 201 having a meandering path design is illustrated. Notably, the superconducting tape segment 201 includes a continuous layer of HTS material that is continuous along the length of the windings, typically without utilization of joints or bridges. The FCL article 200 includes a base 219, a plurality of contacts, including, among others, 203, 204, 205, 206, 207, 209, 210, 211, and 213, a first electrical shunting circuit 215, and a second electrical shunting circuit 217. The meandering path has a plurality of windings, each of which includes straight portions and turns of the superconducting tape segment 201. According to one embodiment, one winding of the superconducting tape segment 201 can include, for example, the path of the tape segment extending around a first contact 203, extending around a second contact 204, and then extending around a third contact 206. As used herein, one winding generally includes any path through which the superconducting tape segment 201 begins and returns to a similar orientation with respect to the contacts. More particularly, a winding is represented by a full cycle, as defined in the context of sinusoidal waves. One winding cycle is shown extending between points A and B. A second winding cycle is shown extending between points C and D.

In further reference to the superconducting tape segment 201, it will be appreciated that while one superconducting tape segment is illustrated in FIG. 2, other embodiments utilize a plurality of superconducting tape segments. For example, multiple superconducting tape segments can be used and joined together using a joint or bridge. These joints can be mechanical and electrical coupling devices, which may be particularly useful for joining a plurality of superconducting tape segments in series. Alternatively, a plurality of superconducting tape segments may be joined in a parallel configuration, such as for example, electrically coupled to form a parallel circuit.

Generally, the superconducting tape segment 201 has a length of not less than about 0.1 m, such as not less than about 5 m, or not less than about 10 m, or even not less than about 1000 m. Typically, the superconducting tape segment 201 has a length that is not greater than about 2 km.

The superconducting tape segment 201 generally has a width of not less than about 0.1 cm. However, other embodiments may utilize a wider superconducting tape segment, such that the width is not less than about 1 cm, or even not less than about 10 cm. Still, the width of the superconducting tape segment is generally not greater than about 30 cm.

Generally, the superconducting tape segment 201 can have an average thickness of not less than about 20 microns, such as not less than about 100 microns, or even not less than about 500 microns. Typically, the average thickness of the superconducting tape segment 201 is within a range of between about 20 microns and about 500 microns, such as between about 50 microns and about 200 microns.

As illustrated in FIG. 2, the superconducting tape segment 201 extends in a meandering path design around a plurality of contacts. According to one embodiment, the superconducting tape segment 201 is suspended. Generally, the superconducting tape segment 201 can be suspended between the contacts to facilitate exposure to a cooling medium. In the particular illustrated embodiment, the superconducting tape segment 201 is suspended between contacts over the base 219. According to a particular embodiment, the superconducting tape segment 201 is suspended over the base 219 on its side, such that planes tangential to the top and bottom surfaces of the tape segment are perpendicular or substantially perpendicular to the major plane of the base 219. According to one embodiment, not less than about 75% of the total length of the superconducting tape segment 201 is suspended above the base 219. In another embodiment, not less than about 90% of the total length of the tape segment is suspended, still, in other embodiments, essentially the entire length of the superconducting tape segment 201 is suspended above the base 219.

According to another embodiment, the entire length of the superconducting tape segment 201 can be suspended at an average height of not less than about 0.25 cm above the base, such as not less than about 0.5 cm, or even not less than about 2 cm above the base. Still, according to another embodiment, portions of the superconducting tape segment 201 can be suspended at different heights over the base 219. For example, half of the entire length of the superconducting tape segment can be suspended at one height, while the other half of the superconducting tape segment can be suspended at a different height. It will be appreciated that portions of the superconducting tape segment do not have to be equal portion and that there may be multiple portions, each of which are suspended at different heights above the base.

In further reference to the suspended tape design, the superconducting tape segment 201 can be suspended on its side and exposed to a cooling medium. Such a design facilitates rapid cooling of the tape segment and increased performance of the FCL device. Accordingly, in one embodiment, not less than about 50% of the total external surface area of the superconducting tape segment 201 is exposed to the cooling medium. In another embodiment, not less than about 75%, such as not less than about 90%, or even not less than about 98% of the total external surface area of the superconducting tape is exposed to the cooling medium.

According to one embodiment, the meandering path design of the superconducting tape segment 201 is an essentially non-inductive design, which facilitates reduction of additional impedances during normal superconducting operation of the FCL article. Generally, the essentially non-inductive design has an inductance of not greater than about 20 micro-Henries, and in some embodiments not greater than about 10 micro-Henries, or even not greater than about 1.0 micro-Henries. According to the embodiment illustrated in FIG. 2, the superconducting tape segment does not overlap itself along the meandering path. Additionally, the superconducting tape segment travels non-linearly but the tape's ends are displaced a distance “d” from the first contact 203 to a final contact 205. The distance between the voltage terminals (Vin and Vout) facilitates a stabilized FCL structure.

Generally, the meandering path design of the FCL article includes winding of the superconducting tape segment that turn around not fewer than 2 electrical contacts, and typically not fewer than 6 electrical contacts, and in some embodiments, not fewer than 10 electrical contacts. As illustrated, the meandering path design can incorporate many more contacts such that the windings of the superconducting tape segment wrap around not fewer than 15 or even 20 contacts. It will be appreciated that the number of contacts may also depend upon the meandering path design and the length of the superconducting tape segment.

In further reference to the design of the FCL article, the contacts are movable. In one embodiment, a portion of the contacts are spring-loaded or biased against the base facilitating movement of the superconducting tape segment 201 and reducing stress to the tape segment, particularly stress to the tape due to expansion and contraction with changes in temperature. Additionally, a portion of the contacts or all of the contacts can include channels for engaging and positioning the superconducting tape segment 201. The channels facilitate turning the winding of the superconducting tape segment around the contacts, directing the winding to the next contact, and maintaining a non-inductive meandering path design.

In further reference to the contacts of the FCL article, according to one embodiment, a portion of the contacts are electrical contacts, while the remaining contacts are mechanical. Generally, contacts which are electrical contacts are made of an electrically conductive material or have an electrically conductive coating. Suitable materials for the electrical contacts include a noble metal, such as silver, gold, or non-noble metals such as copper, or alloys thereof. Referring to the embodiment illustrated in FIG. 2, contacts 203, 210, and 205 are particularly suited to be electrical contacts, given that these contacts electrically couple the FCL device to an outside electrical device, evidenced by Vin and Vout, as well as electrically couple the first shunting circuit 215 and the second shunting circuit 217 to each other and the superconducting tape segment 201. Additionally, other contacts of the FCL device can be electrical contacts, and according to one embodiment, every other contact is an electrical contact. Yet, in another embodiment, all of the contacts are electrical contacts.

In reference to the design of the superconducting tape segment 201 and the contacts, the design of the meandering path can determine the surface (i.e., the top or bottom surface) of the superconducting tape segment that electrically couples to the electrical contacts. Generally, the superconducting tape segment 201 has a bottom surface defined by the substrate and a top surface defined by the surface of the tape segment opposite of the bottom surface, which may include one of many different layers, such as for example the HTS layer, the capping layer, or the stabilizer layer. Accordingly, it may be desirable for a portion of the top surface or a portion of the bottom surface of the superconducting tape segment to contact the electrical contacts. In one embodiment, portions of the bottom surface and portions of the top surface of the superconducting tape segment can couple to the electrical contacts. According to another embodiment, portions of the top surface of the superconducting tape segment 201 extend around all of the contacts. In another embodiment, portions of the bottom surface of the superconducting tape segment 201 extend around all of the electrical contacts.

For example, referring to the meandering path design illustrated in FIG. 2, a portion of the top surface of the superconducting tape segment may extend around contact 203, accordingly then a portion of the back surface of the superconducting tape segment extends around contact 204, and likewise, a portion of the top surface extends around contact 206. Contacts 203 and 206 can be electrical contacts, and as such, the top portion of the superconducting tape segment extends around and is coupled to electrical contacts 203 and 206. Still, contact 204 may be an electrical contact and a portion of the bottom surface of the superconducting tape segment is electrically coupled to electrical contact 204. It will be appreciated, that the meandering path design, the orientation of the superconducting tape segment, and number and placement of electrical contacts can determine those surfaces of the superconducting tape segment that electrically couple the tape segment with the electrical contacts.

The FCL device also includes a shunting circuit to facilitate current flow when the superconducting tape segment is in a non-superconducting state, which typically involves fault currents above a particular threshold. According to one embodiment, the FCL article includes one shunting circuit. With regards to the embodiment illustrated in FIG. 2, a first shunting circuit 215 and a second shunting circuit 217 are coupled to the superconducting tape segment 201 and contacts 203 and 205, which generally are electrical contacts. The shunting circuits 215 and 217 can be electrically coupled to the superconducting tape segment 201 through electrical contact, or alternatively, inductively coupled. As illustrated, the first shunting circuit 215 spans a portion of the meandering path and is electrically coupled to electrical contacts 203 and 210. The second shunting circuit 217 spans a portion of the meandering path and is electrically coupled to electrical contacts 210 and 205. Notably, the first and second shunting circuits 215 and 217 span the distance “d” and provide an alternative current flow path between Vin and Vout, for current flow during a fault state. Additionally, the first and second shunting circuits 215 and 217 facilitate an alternative current flow path in cases of damage or failure of the superconducting tape segment 201, ensuring performance of the device.

Accordingly, the FCL device can include a single or a plurality of shunting circuits spanning the entire distance of the meandering path between Vin and Vout. As illustrated in FIG. 2, each of the first and second shunting circuits 215 and 217 span a number of contacts without making electrical contact. More shunting circuits can be included, and according to one embodiment, the FCL device incorporates a shunting circuit contacting each of the electrical contacts to maximize alternative current flow paths in case of damage or failure to the tape. According to one embodiment, the shunting circuit includes at least one impedance element (i.e., resistors and/or inductors) and more typically a plurality of impedance elements, spanning the distance of the meandering path between Vin and Vout. In one embodiment, the plurality of impedance elements can be connected in series to each other. The number of impedance elements connected in series is generally greater than about 2, such as not less than about 5, or even not less than about 10 impedance elements. Alternatively, the series of impedance elements can be connected in series with electrical contacts. In one particular embodiment, the series of impedance elements is coupled to each of the electrical contacts.

Generally, the impedance elements are selected to have a particular impedance based upon the length of tape that the shunting circuit spans such that each impedance element protects a certain length of the superconducting tape segment. As such, typically the shunting circuit includes impedance elements having an impedance of not less than about 0.1 milliOhms per meter of tape protected. Other embodiments utilize a greater impedance per length of tape protected, such that the impedance elements have a value of not less than about 1 milliOhms per meter of tape protected, or not less than about 5 milliOhms per meter of tape protected, or even not less than about 10 milliOhms per meter of tape protected, and even up to about 1.0 Ohm per meter of tape protected.

The shunting circuits herein typically incorporate a particular number of impedance elements per length of superconducting tape segment. For example, the shunting circuit can incorporate one impedance element for not less than about 5 meters of superconducting tape segment. Other embodiments may use less elements, such as one impedance element for not less than about 10 meters of superconducting tape segment protected, or even one impedance element for not less than about 20 meters of superconducting tape segment protected. Still, embodiments herein typically utilize at least one impedance element per 100 meters of superconducting tape protected.

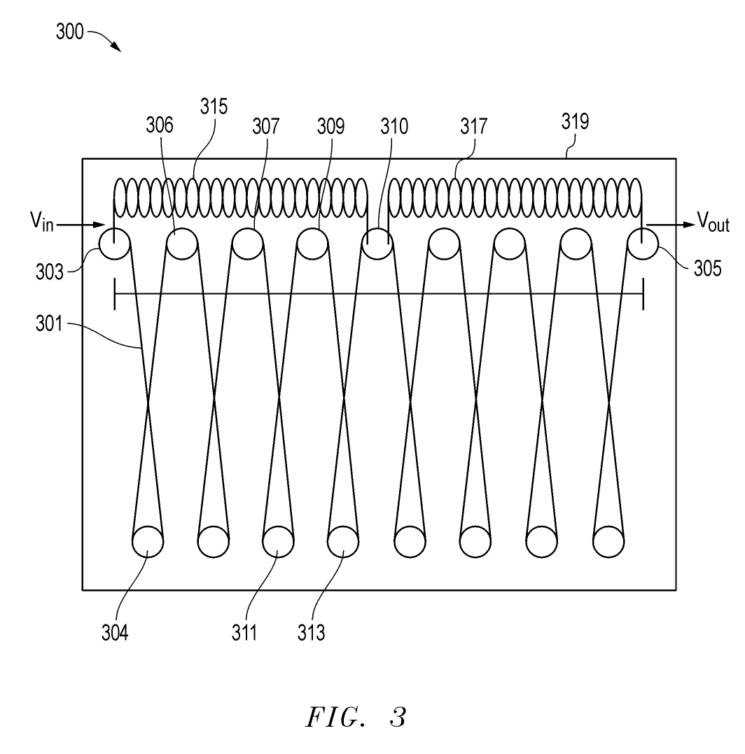

Referring to FIG. 3, a diagram of a FCL article 300 including a superconducting tape segment 301 having an alternative meandering path design is illustrated. The FCL article includes a base 319, a plurality of contacts (including, among others) 303, 304, 305, 306, 307, 309, 310, 311, and 313, and a first electrical shunting circuit 315 and a second electrical shunting circuit 317. According to this embodiment, the windings, includes straight portions and turns of the superconducting tape segment 301, however, the windings overlap each other. According to the illustrated embodiment, one winding of the superconducting tape segment includes, for example, the path of the tape segment from first contact 303 to a second contact 304 and then extending around a third contact 306. Notably, in this particular meandering path design, the superconducting tape segment 301 overlaps itself as it travels through each winding. Accordingly, different portions of the superconducting tape segment 301 are positioned at different heights over the base to facilitate the overlapping pattern. For example, the portion of the superconducting tape segment that extends between contact 303 and contact 304 may overlap or underlap the portion of the superconducting tape segment that extends between contact 304 and contact 306.

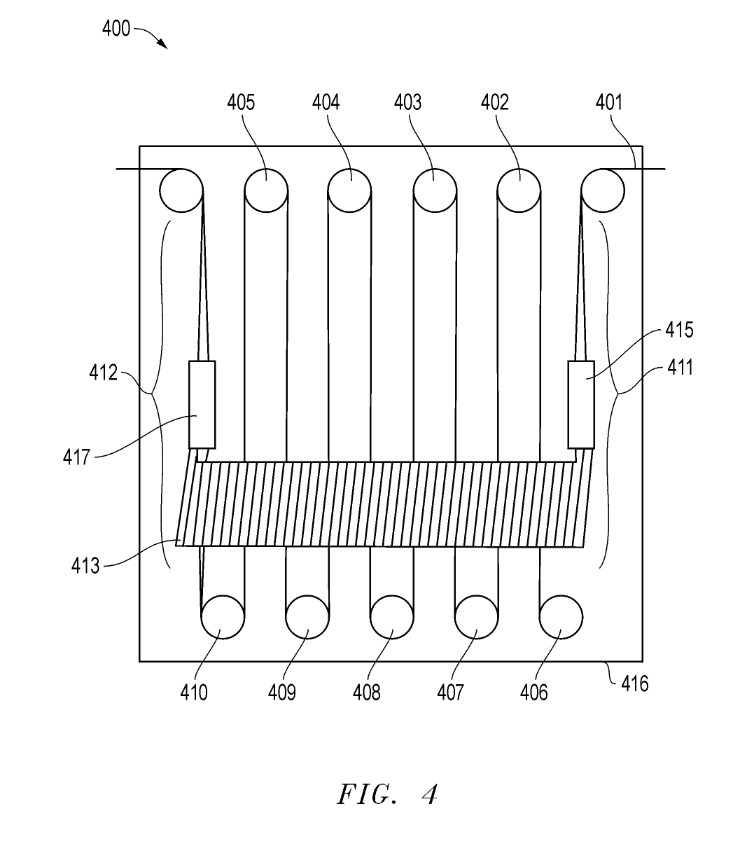

Referring to FIG. 4, a FCL article 400 is illustrated that includes a superconducting tape segment 401 having a plurality of windings in an alternative meandering path design. As illustrated, the FCL article 400 includes a plurality of contacts such as 402-410, overlying a base 416. While as described above such contacts 402-410 can include mechanical or electrical contacts, in this particular embodiment, the contacts 402-410 are mechanical contacts for turning the superconducting tape segment 401. Unlike previous described embodiments, the superconducting tape segment 401 includes rotation regions 411 and 412 where the superconducting tape segment 401 is tilted or rotated. According to the illustrated embodiment, the rotation regions 411 and 412 are particularly localized along straight portions of the superconducting tape segment 401. Such rotation regions 411 and 412 facilitate coupling of the superconducting tape segment 401 to electrical contacts 415 and 417, which in turn couple the superconducting tape segment 401 to a shunting circuit 413. Notably, within the rotation regions 411 and 412 the superconducting tape segment 401 is rotated such that at least a portion of the superconducting tape segment 401 is parallel to the base 416 and lies flat against a contact surface of the electrical contacts 415 and 417. It will be appreciated that according to one embodiment, multiple parallel windings of superconducting tape segments can be incorporated into such an embodiment, all of which may be rotated to facilitate a connection to electrical contacts.

The superconducting tape segment 401 within the rotation regions 411 and 412 can be rotated around a longitudinal axis extending the length of the superconducting tape segment 401. Typically, the amount of rotation of the superconducting tape segment 401 within the rotation regions 411 and 412 is not less than about 15° relative to other non-rotated portions of the tape. Other embodiments utilize a greater amount of rotation, such as not less than about 30°, or not less than about 45°, or even not less than about 60°. Still, the amount of rotation of the tape segment 401 within the rotation regions 411 and 412 is typically not greater than about 150°.

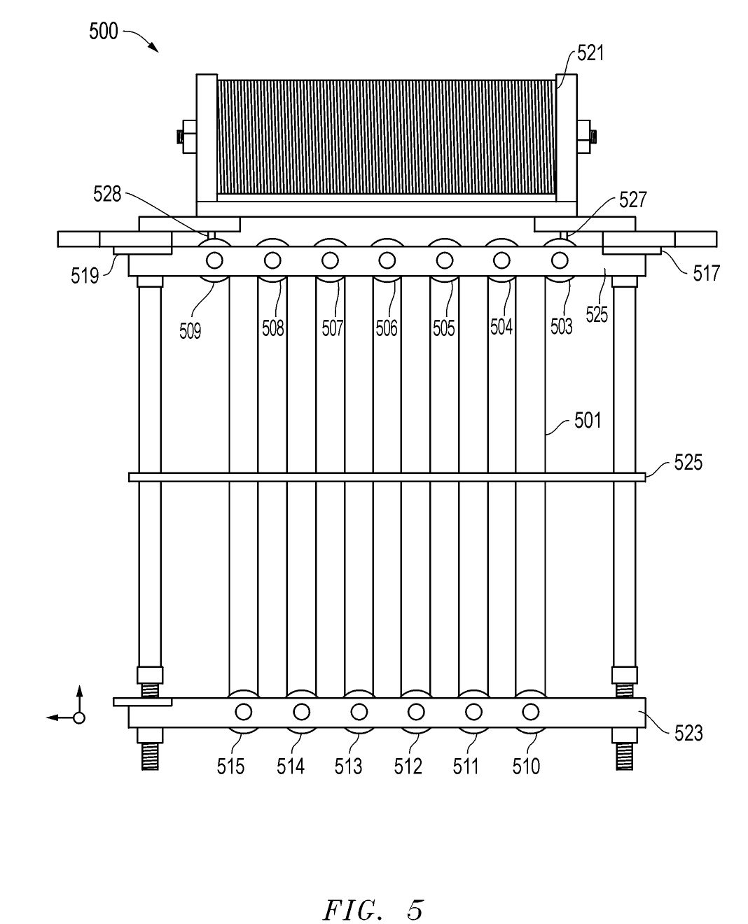

Referring to FIG. 5 a FCL article 500 having an alternative design is illustrated. The FCL article 500 includes at least one superconducting tape segment 501 having a plurality of windings including straight portions and turns, wherein the turns are made around a plurality of contacts 503-515. According to the illustrated embodiment, the superconducting tape segment 501 is suspended between the contacts 503-515 facilitating effective exposure of the superconducting tape segment 501 to a coolant, such as a cryogenic liquid or gas. Notably, FCL article 500 does not include a base, rather the contacts 503-515 are supported by structures 523 and 525. The FCL article 500 further includes end plates 517 and 519 for retaining the superconducting tape segment 501 within the structure.

Moreover, a plate 525 is located between the structures 523 and 525 and contains openings for passage of the superconducting tape segment 501 therethrough. The openings within the plate 525 may help stabilize the windings of the superconducting tape segment relative to each other, such that each of the windings do not come in contact with adjacent winding portions and cause electrical interferences.

The illustrated embodiment further includes a shunting circuit 521 electrically coupled to the superconducting tape segment 501 through electrical contacts 527 and 528. While other embodiments may utilize a combination of mechanical and electrical contacts to change the path of the superconducting tape segment as described above, according to this particular embodiment, the electrical contacts 527 and 528 are positioned separately from contacts 503-515 for efficient electrical coupling of the superconducting tape segment 501 and the shunting circuit 521. As such, according to this particular embodiment, the superconducting tape segment 501 does not wrap around the electrical contacts 527 and 528. It will be appreciated that such an embodiment may incorporate multiple superconducting tape segments.

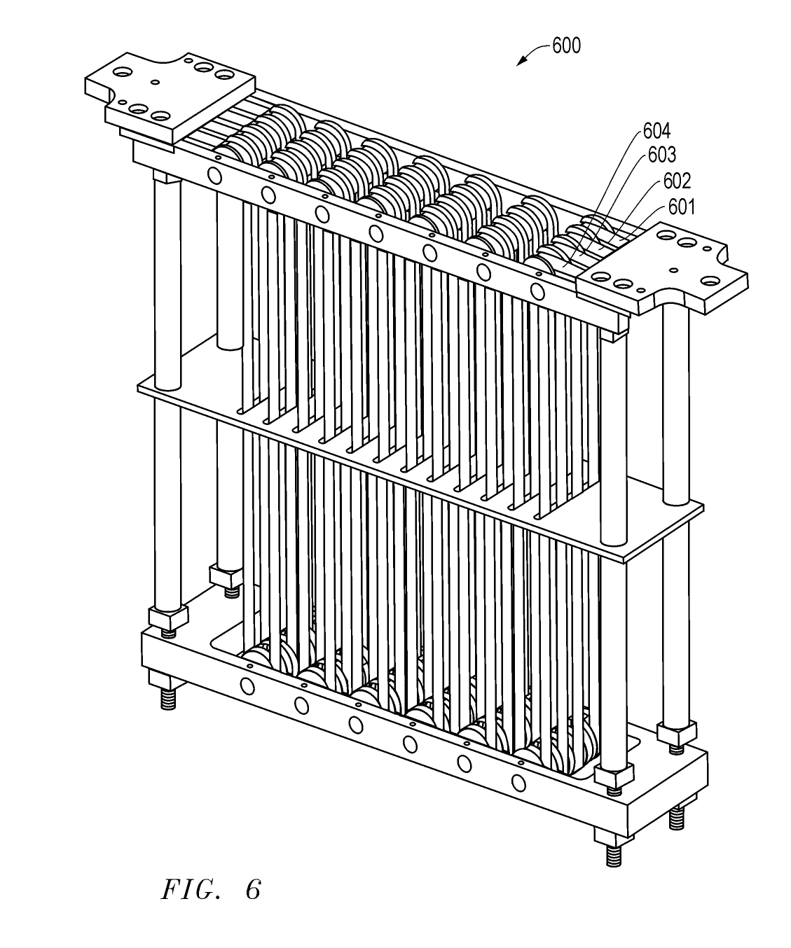

FIG. 6 is a perspective view of a FCL article 600 having a similar configuration to the FCL article 500, however, the FCL article 600 includes multiple superconducting tape segments 601, 602, 603 and 604, each having a plurality of windings comprising straight portions and turns which extend around the plurality of contacts. According to the illustrated embodiment, the superconducting tape segments 601-604 are positioned adjacent to each other, such that the straight portions of each of the superconducting tape segments 601-604 extend along the same plane. Moreover, each of the superconducting tape segments 601-604 have turns which extend around contacts and which are adjacent to each other. Each of the superconducting tape segments 601-604 have substantially similar paths except that they are displaced a lateral distance from an adjacent tape thereby reducing tape-to-tape electromagnetic interferences. Generally, the average lateral distance between adjacent tapes, as measured from the closest lateral edges between adjacent tapes, is not greater than about 5 cm. Other embodiments may utilize a closer spacing such that the average lateral distance between adjacent tapes is not greater than about 1 cm, such as not greater than about 0.5 cm, or even not greater than about 0.1 cm.

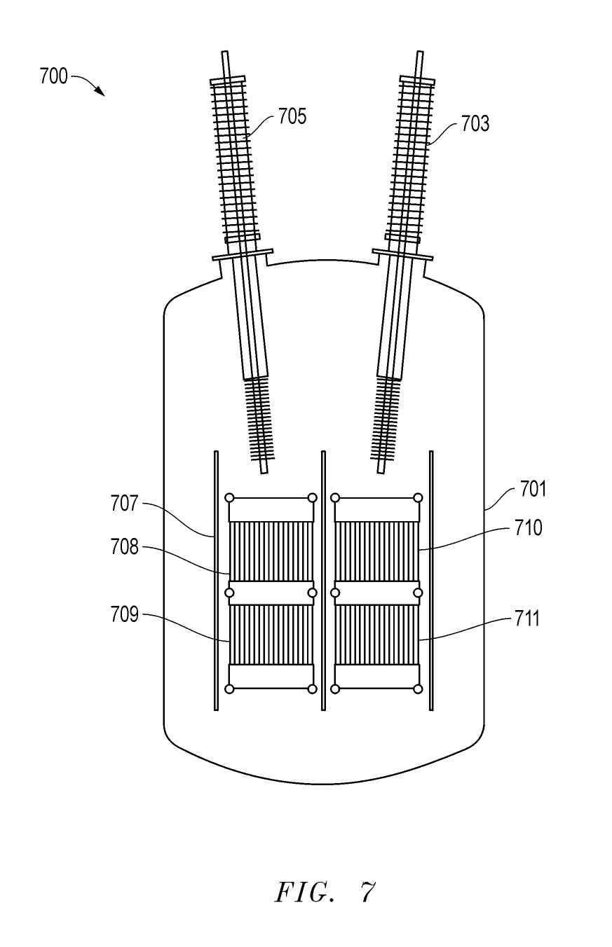

Referring to FIG. 7, a FCL article 700 is illustrated that includes a housing 701, bushings 703 and 705, and a matrix assembly 707 having a plurality of superconducting FCL assemblies 708, 709, 710, and 711 (708-711). According to a particular embodiment, the housing 701 is temperature and pressure controlled, particularly, cryogenically cooled to sustain temperatures appropriate for the superconducting FCL assemblies. As described above, this temperature can be maintained by liquid nitrogen or other liquid cryogen. Generally, the bushings 703 and 705 can be electrically coupled to outside power generation, transmission and distribution devices, while inside the housing 501 the bushings 703 and 705 electrically couple the matrix assembly 707 including the superconducting FCL assemblies 708-711. It will be appreciated that the superconducting FCL assemblies 708-711 incorporate components and designs as described among the embodiments herein.

FIG. 8 illustrates a schematic of a FCL device 803 placed in a power grid 800 according to one embodiment. As illustrated, the schematic 800 includes placement of the FCL device 803 in a “main position”, that is, in a position between a transformer 801 and a distribution bus 805 that includes a plurality of individual circuits. Notably, placement of a FCL device in the main position protects all users on the distribution bus 805 without breaker upgrades.

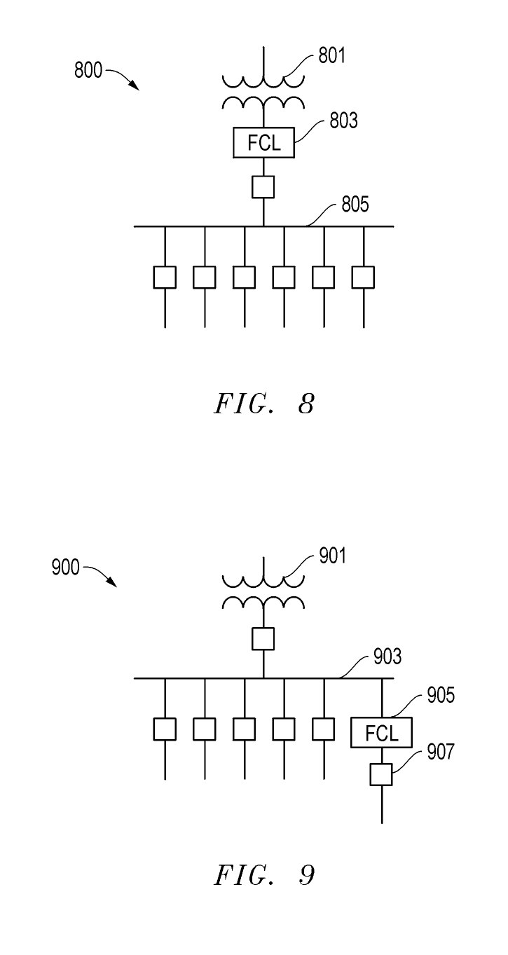

Turning to another schematic, FIG. 9 illustrates placement of a FCL device 905 in a power grid 900 according to one embodiment. As illustrated, the schematic demonstrates placement of the FCL device 905 downstream of a transformer 901, and a distribution bus 903, but before an individual circuit 907. This demonstrates the use of the FCL device 905 in a “feeder position”, which protects the individual circuit 907 and underrated devices on the individual circuit 907. Notably, the FCL device 905 in the feeder position can be a smaller device as it may not necessarily need to be equipped to deal with large loads.

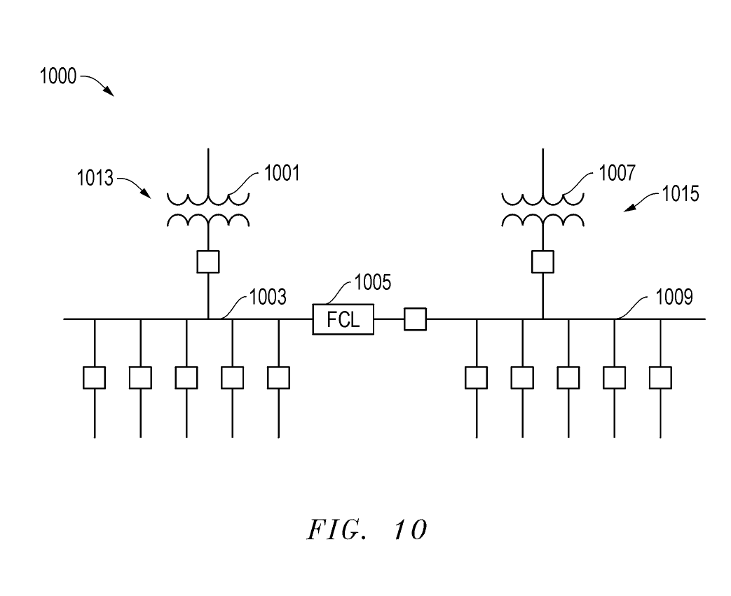

Turning to another schematic, FIG. 10 illustrates placement of a FCL device 1005 in a power grid 1000 according to one embodiment. As illustrated, the schematic demonstrates placement of the FCL device 1005 between two sub-systems 1013 and 1015 each equipped with a transformer 1001 and 1007, and distribution buses 803 and 1009, but before an individual circuit 1007. This demonstrates the use of the FCL device 1005 in a “bus-tie position”, which protects from fault currents propagating in one sub-system interfering with circuits on another sub-system.

In reference to the electrical properties of the FCL device and components of the FCL device, in one embodiment, the superconducting tape segment has a resistivity of not greater than about 5 Ohms per meter in the non-superconducting state. According to another embodiment, the superconducting tape segment has a resistivity of not greater than about 2 Ohms per meter, such as not greater than about 1 Ohms per meter, or even, not greater than about 0.1 Ohms per meter in the non-superconducting state.

Notably, the FCL article has an impedance ratio that is a measure of the impedance between the superconducting tape segment and the shunting circuit when the article is in the non-superconducting state. Generally, the impedance ratio is not less than about 1:1, and more typically, not less than about 3:1 between the superconducting tape segment and the shunting circuit when the article is in the non-superconducting state. According to one embodiment, the impedance ratio is not less than about 10:1, or not less than about 30:1, or even not less than about 100:1. According to a particular embodiment, the impedance ratio of the FCL device is within a range of between 5:1 and 50:1.

In further reference to characteristics of the article, according to one embodiment, the superconducting tape segment includes a capping layer having an average thickness of not greater than about 50 microns. According to another embodiment, the capping layer, which overlies the HTS layer, has an average thickness not greater than about 25 microns, such as not greater than about 5 microns, or still, not greater than about 0.05 microns. In one particular embodiment, the superconducting tape segment is essentially free of a capping layer overlying the HTS layer.

According to another embodiment, the superconducting tape may include a stabilizer layer that overlies the capping layer (in embodiments where the capping layer is provided) or otherwise overlies the HTS layer directly, in which the average thickness of the stabilizer layer is not greater than about 1000 microns. According to another embodiment, the stabilizer layer has an average thickness of not greater than about 500 microns, such as not greater than about 50 microns, or even not greater than about 2 microns. Still, in a particular embodiment, the superconducting tape segment is essentially free of a stabilizer layer.

In further reference to the design of the superconducting tape segment, the thickness of the substrate can be selected to provide desired electrical characteristics. According to one embodiment, the average thickness of the substrate is not less than about 10 microns, such as not less than about 50 microns, or even, not less than about 100 microns. Still, in another embodiment, the average thickness of the substrate is not less than about 200 microns, such as not less than about 1000 microns. In a particular embodiment, the average thickness of the substrate is within a range of between about 100 microns and 300 microns, such as between about 150 microns and 250 microns.

In further reference to characteristics of the FCL device, generally the critical current capacity of the superconducting tape segment in the superconducting state is a measure of the current per dimension of width of tape. As such, typically the critical current capacity not less than about 5 A/cm width of tape. In another embodiment, the critical current capacity is greater, such as not less than about 50 A/cm width of tape, or not less than about 100 A/cm width of tape, or even not less than about 1000 A/cm width of tape. Particular embodiments may utilize a critical current capacity within a range between about 10 A/cm width of tape to about 1000 A/cm width of tape, and more particularly within a range between about 100 A/cm width of tape and about 750 A/cm width of tape. If the current exceeds this critical current capacity the superconductor will undergo a transition from its superconducting state to a “normal resistive state.” This transition of a superconductor from a superconducting state to a normal resistive state is termed “quenching.” Quenching can occur if any one or any combination of the three factors, namely the operating temperature, external magnetic field or current level, exceeds their corresponding critical level.

According to one embodiment, the primary quenching trigger of the FCL device provided herein, is a quench current. Typically, the lower the quench current, the more responsive the device to fault currents. The quench current can be a measured multiple of the critical current capacity of the superconducting tape segment. For example, in one embodiment, the FCL has a sensitivity such that a quench current of not greater than about 20 times the critical current capacity is sufficient to cause quenching of the superconducting tape segment. In other embodiments, the quench current can be less, such as not greater than about 10 times the critical current capacity of the superconducting tape segment. Other embodiments utilize a quench current of not greater than about 5 times the critical current capacity of the superconducting tape segment, or not greater than about 2.5 times the critical current capacity of the superconducting tape segment. According to a particular embodiment, the quench current is not greater than about 1.5 times the critical current capacity.

Generally, the lower the quench current, the quicker the response time of the FCL article, which ensures improved protection of downstream electric devices. The response time of the FCL article then is the time it takes to quench the superconducting tape segment. Generally, the average response time is less than half of one frequency cycle. According to one embodiment, the average response time is not greater than about 10 ms, such as not greater than about 2 ms, or even not greater than about 0.5 ms. Still, in another embodiment, the response time was not greater than about 0.1 ms. In more particular embodiments, the average response time can be within a range between about 0.1 ms and about 5 ms.

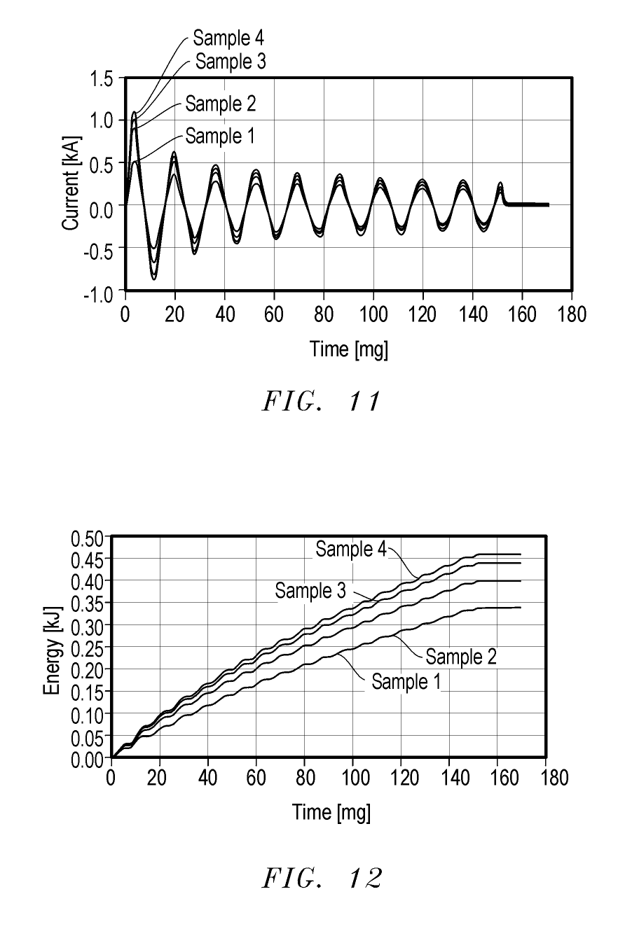

In further reference to characteristics of FCL articles, FIG. 11 illustrates a plot of current versus time for four superconducting tape segment test samples connected with a parallel shunt circuit incorporating designs in accordance with embodiments herein. A prospective fault current of 3000 A is applied to four superconducting tape segment test samples (Samples 1-4). The FCL article includes a 10 micro Ohm inductively coupled shunting circuit. Each of the four samples includes the same layers, notably a substrate, buffer layer, HTS layer and a capping layer. However, the thickness of the capping layer for each of the four samples is varied. Sample 1 includes a capping layer comprising silver having a thickness of 1.2 microns. While samples 2, 3, and 4, include capping layers having thicknesses of 2.4 microns, 3.6 microns, and 4.8 microns respectively. According to FIG. 11, Sample 1 demonstrates the lowest initial peak current upon application of the fault current, while Sample 2 provides a higher initial peak current, Sample 3 has a greater initial peak current than Sample 2, and Sample 4 demonstrates an initial peak current greater than all of the other samples. As illustrated, as the oscillations continue and decrease in intensity with time, Sample 1 continues to demonstrate the lowest peak currents and Sample 4 has the greatest peak currents. Notably, the test samples having a capping layer of reduced thickness demonstrate a capability to divert current flow from the superconducting tape segment to the shunting circuit under fault conditions.

Turning to FIG. 12, a plot of energy versus time is illustrated for the same four test samples. Samples 1-4 are the same as the samples discussed above in accordance with FIG. 11. The samples are tested under the same conditions, having the same layered structure, including a substrate, buffer layer, HTS layer, and a capping layer, except that each of the samples has a silver capping layer of a different thickness. As provided above, Samples 1-4 have capping layer thicknesses of 1.2 microns, 2.4 microns, 3.6 microns, and 4.8 microns respectively. According to this test, the measured energy includes the thermal energy of the test samples when subjected to a fault current in parallel with a shunt circuit. As illustrated, Sample 1 demonstrates the smallest increase in total energy over the duration of the fault, while Sample 2 demonstrates a greater increase in total energy over the duration of the fault. Samples 3 and 4 demonstrate even greater increase in total energy over the duration of the fault, with Sample 4 having the highest increase in total energy. The increase in energy of the samples is due primarily to the corresponding current flowing in the superconducting tape segment as determined by the parallel shunt impedance. A lower total increase in energy facilitates a device that has increased performance, response time and recovery time, as well as a likely increase in durability and operational lifetime. Accordingly, the plot of FIG. 12 indicates that samples having a reduced thickness capping layer may facilitate improved energy dissipation and improved superconducting tape segments for FCL devices.

According to embodiments described above, FCL articles incorporating superconducting tape segments are provided that have notably improved performance, and durability. In particular, present embodiments describe a combination of features including, unique device designs, non-inductive meandering path designs, and utilization of particular long-length, multilayered superconducting structures for FCL devices. Moreover, present embodiments also represent a departure from the state of the art by providing the above combination of features with engineered continuous lengths of superconducting tape segments for particular use in meandering path FCL devices. It has been discovered that particular designs of the multi-layered structure as described in embodiments herein provide noteworthy improvements. It has also been discovered that the combination of features provided in embodiments herein enable improved FCL devices having improved performance, response time, recovery time, durability and operational lifetime.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A fault current limiter (FCL) article comprising:
a superconducting tape segment comprising:
a substrate;
a buffer layer overlying the substrate; and
a high temperature superconducting (HTS) layer overlying the buffer layer, wherein the superconducting tape segment forms a meandering path that is continuous, the meandering path having a plurality of windings; and
a shunting circuit electrically connected to the superconducting tape segment.

2-4. (canceled)

5. The FCL article of claim 1, wherein the meandering path of the superconducting tape segment forms an essentially non-inductive electrical path.

6-10. (canceled)

11. The FCL article of claim 1, wherein a portion of the superconducting tape segment is suspended between contacts and exposed to a cooling medium.

12-14. (canceled)

15. The FCL article of claim 11, wherein the superconducting tape segment has a total external surface area, and not less than about 50% of the total external surface area of the superconducting tape segment is exposed to the cooling medium.

16-21. (canceled)

22. The FCL article of claim 1, wherein each winding comprises at least one turn and a straight portion.

23-24. (canceled)

25. The FCL article of claim 22, wherein at least several of the turns wrap around electrical contacts.

26. The FCL article of claim 25, wherein the superconducting tape segment has a bottom surface defined by the substrate surface and a top surface opposite the bottom surface, and wherein the top surface physically contacts the respective electrical contact.

27-28. (canceled)

29. The FCL article of claim 25, wherein a portion of the electrical contacts of are movable.

30. (canceled)

31. The FCL article of claim 25, wherein the shunting circuit comprises at least one impedance element positioned between the electrical contacts and electrically coupled to the electrical contacts.

32-33. (canceled)

34. The FCL article of claim 31, wherein the at least one impedance element has an impedance of not less than about 0.1 milliOhms per meter of meander path protected.

35-37. (canceled)

38. The FCL article of claim 1, wherein the buffer layer comprises at least one biaxially textured film having biaxially aligned crystals both in-plane and out-of plane of the film.

39-41. (canceled)

42. The FCL article of claim 1, wherein the superconducting tape segment further comprises a capping layer overlying the HTS layer.

43. (canceled)

44. The FCL article of claim 42, wherein the capping layer has an average thickness of not greater than about 50 microns.

45. (canceled)

46. The FCL article of claim 1, wherein the superconducting article is essentially free of a capping layer overlying the HTS layer.

47. The FCL article of claim 1, wherein the superconducting article is essentially free of a stabilizing layer overlying the HTS layer.

48. (canceled)

49. The FCL article of claim 1, wherein the substrate has an average thickness of not less than about 10 microns.

50-51. (canceled)

52. The FCL article of claim 1, wherein the critical current capacity of the superconducting tape segment in the superconducting state is not less than about 5 A/cm width of tape.

53. The FCL article of claim 52, wherein the quench current is not greater than 5 times the total critical current capacity of the superconducting tape segment.

54. (canceled)

55. The FCL article of claim 1, wherein the superconducting tape segment comprises a central axis extending the length of the superconducting tape segment and the superconducting tape segment is rotated about the central axis to form a locally rotated portion.

56. The FCL article of claim 55, wherein the superconducting tape is coupled to an electrical contact at the locally rotated portion.

57-59. (canceled)
